(19) United States
(12) Patent Application Publication
(10) Pub. No.: US 2005/0008445 A1
(43) Pub. Date: Jan. 13, 2005

(54) Wall nail with inner strips

(76) Inventor: Ming-Tien Yeh, Chunghua (TW)

Correspondence Address: Ming-Tien Yeh, 235 Chung - Ho, Box 8-24, Taipei, TW

(21) Appl. No.: 10/623,453

(22) Filed: Jul. 21, 2003

Related U.S. Application Data
(63) Continuation-in-part of application No. 10/228,749, filed on Aug. 27, 2002, now Pat. No. 6,749,385.

(51) Int. Cl. F16B 13/06

(52) U.S. Cl. 411/45

(57) ABSTRACT

A nail structure comprises a wall nail casing and a hammer nail capable of being beaten into the wall nail casing. A plurality of semi-round strips are axially installed on the through hole of the wall nail casing. Each strip is reduced from an opening of the central axial hole to the middle section of the wall nail casing for firmly securing the hammer nail. The hammer nail is positioned to an opening of the wall nail casing and resists against the strips. Thereby, the hammer nail is loosely fixed to the strips. The hammer nail is sold with a matched wall nail casing. When using, the hammer nail is not necessary to be detached from the wall nail casing so that the user can beat the hammer nail directly with the wall nail casing.

This is the continuation in part of the U.S. patent Ser. No. 10/228,749 which is filed by the inventor of this application. The contents of U.S. patent Ser. No. 10/228,749 are thus incorporated into the present invention as a part of this specification.

### FIELD OF THE INVENTION

The present invention relates to wall nails, and particularly to wall nail with inner strips, where the wall nail has a wall nail casing and a hammer nail. When the hammer nail is beaten into the central axial hole of the wall nail casing, the hammer nail expands the central axial hole outwards to prevent the hammer nail to damage the wall nail casing.

### BACKGROUND OF THE INVENTION

Referring to FIGS. 1A to 1D, prior art wall nails are illustrated. The prior art wall nails can be divided into two classes, one is wall nails with inner tapered holes as shown in FIGS. 1A and 1B, and the other is two flat inner wall nails as shown in FIGS. 1C and 1D. The prior art wall nails are mainly formed by wall nail casings 3′ and hammer nails 2 beaten into the wall nail casings 3′. The wall nail has a stepped hole 10 at an opening for receiving the hammer nail 2. The stepped hole 10 is a rectangular hole and is tapered to have a small size at the end of a central axial hole 131′ far away from the opening. The central axial hole 131′ is at a center of the inner tapered wall nail casing 3′. The tail end of the wall nail casing 3′ is formed with a round hole 135′ and a rear section thereof is formed with a slot 133′. When the hammer nail 2 is beaten into the central axial hole 131′, the wall nail casing 3′ will be expanded along the round hole 135′ from the slot 133′.

For the two flat inner wall nail casing 3″ as shown in FIGS. C and D, a round hole 131″ is formed at the front inner side thereof. Two float surface vertical wall 132″ are formed in the wall of the hole 131′. The two vertical walls 132″ are extended to another opening 135″ of the wall nail casing 3″. The two sides of the wall without the flat walls 132″ are formed with slots 133′. A hammer nail 2 can be beaten into the wall nail casing 3″ from the round hole 131′ and then moves forwards to touch the two flat walls 132″. The hammer nail 2 can expand the two flat walls 132″ so as to firmly secure the wall nail casing 3′. However, the two said two prior art wall nails are not so good as predicted when they are used.

This is because the head of the wall nail casing 3′ and 3″ is formed with a round stepped hole 10 which is not beneficial to the hammer nail 2 as the hammer nail 2 is beaten into the wall nail. This is a the hammer nail 2 can not be exactly beaten into the stepped hole 10. Even the hammer nail 2 is beaten into the wall nail casing 3′, the wall nail casing 3′ or 3″ is easy to release out since the engagement between the hammer nail 2 and the wall nail are loose. In general, the manufacturing error of the hammer nail 2 is about 0.02 m/m. If the hammer nail 2 is overlarge, the wall nail casing 3′ or 3″ will over-expand so that the wall nail casing 3′ or 3″ falls down from the wall surface. To fix the wall nail in the wall, the user must beat the hammer nail 2 deeply, but this will induce that the wall nail casing 3′ or 3″ is damaged so that the wall nail can not be used.

For above mentioned wall nails with two flat inner wall, the above mentioned condition occurred in wall nails having tapered holes possibly occurs since the inner walls are flat so that only line contact with the hammer nail 2. This will induce that the stresses are applied on the two lines so that the wall nail casing expands non-uniformly. Thus, the wall nail is easy to be damaged.

Thereby, if the manufacturer desires to sell the wall nails (including wall nails with tapered holes and with two flat inner walls) with the hammer nail being loosely engaged to the wall nail casing 3′ or 3″, the hammer nails 2 and matched wall nail casings 3′ or 3″ are sold together in a loose assembled state. The hammer nails 2 can not be well fixed to the wall nail casings 3′ or 3″ (as stated above, the hammer nails 2 may damage the wall nail casings due to over-expansion). If the wall nail is used, the hammer nail 2 will damage the wall nail casing 3′ or 3″. Thereby, the user must buy the hammer nail and wall nail casing separately. That is, the user buys the hammer nails (or wall nail casing firstly) and then buys the wall nail casing (or hammer nail) matched to the hammer nail (or wall nail casing). This is inconvenient to users.

### SUMMARY OF THE INVENTION

Accordingly the primary object of the present invention is to provide a nail structure which comprises a wall nail casing and a hammer nail capable of being beaten into the wall nail casing. A plurality of semi-round strips are axially installed on a through hole of the wall nail casing. Each strip is reduced from an opening of the central axial hole to the middle section of the wall nail casing. The hammer nail is positioned to an opening of the wall nail casing and resists against the strips. Thereby, the hammer nail is loosely fixed to the strips. The hammer nail is sold with a matched wall nail casing. When using, the hammer nail is not necessary to be detached from the wall nail casing so that the user can beat the hammer nail directly with the wall nail casing.

Another object of the present invention is to provide a nail structure, wherein the distal end of the wall nail casing is not expanded by the hammer nail. The strips have round shape so that the hammer nail can be buffered by the strips. Since a plurality of strips are arranged around the inner wall of the wall nail casing, the hammer nail does not wholly contact with the wall of the wall nail casing.

A further object of the present invention is to provide a nail structure, wherein a center of the wall nail casing is formed with a tapered central axial hole. A head portion of the wall nail casing connected to central axial hole is formed with a tapered throat portion. The various objects and advantages of the present invention will be more readily understood from the following detailed description when read in conjunction with the appended drawing.

### BRIEF DESCRIPTION OF THE DRAWINGS

FIG. 1A is a cross sectional view of the round tapered wall nail casing of the prior art.

FIG. 1B is a plane view showing the tail end of the round tapered wall nail casing of the prior art.

FIG. 1C is a cross sectional view of the prior art wall nail casing with two flat inner walls.

FIG. 1D is a plane view showing the tail end of the prior art wall nail casing with two flat inner walls.

FIG. 2 is a perspective view of the prior art in FIG. 1.

FIGS. 3 and 3A is a cross sectional view of the wall nail casing of the present invention.

FIG. 4 is a perspective view showing the wall nail casing and hammer nail of the present invention.

FIGS. 5 to 7 is an exploded view about the wall nail casing arid hammer nail of the present invention.

FIGS. 8 and 9 are schematic view showing the operation of the hammer nail and the wall nail casing of the present invention.

### DETAILED DESCRIPTION OF THE PREFERRED EMBODIMENTS

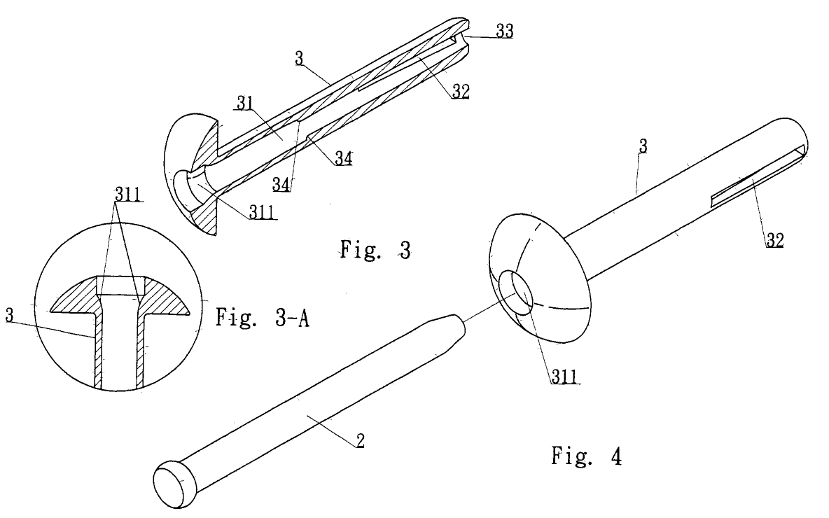

Referring to FIGS. 3, 4, and 5, the structure of the present invention is illustrated. The present invention is formed by a wall nail casing 3 capable fixed to a wall and a hammer nail 2 which is beaten into an inner side of the wall nail casing 3.

A center of the wall nail casing 3 is formed with a tapered central axial hole 31. A head portion of the wall nail casing 3 connected to central axial hole 31 is formed with a tapered throat position 311.

Two sides of the distal end of the wall nail casing 3 are formed with an expandable slot 32. After forming the wall nail casing 3, a front end is installed with a through hole 33 communicable to the central axial hole 31 so that the whole wall nail casing 3 is hollowed axially.

A plurality of semi-round strips 34 are longitudinally installed on through hole 33 of the wall nail casing 3 near the central axial hole 31. Each strip 34 is reduced from with the distance to the head portion of the wall nail casing.

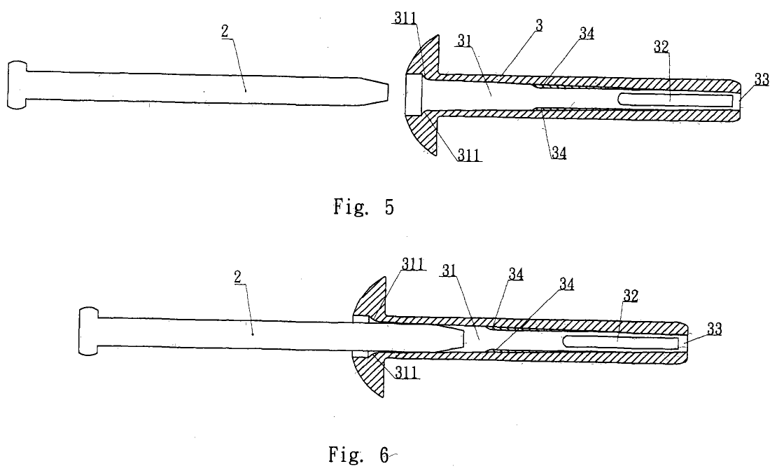

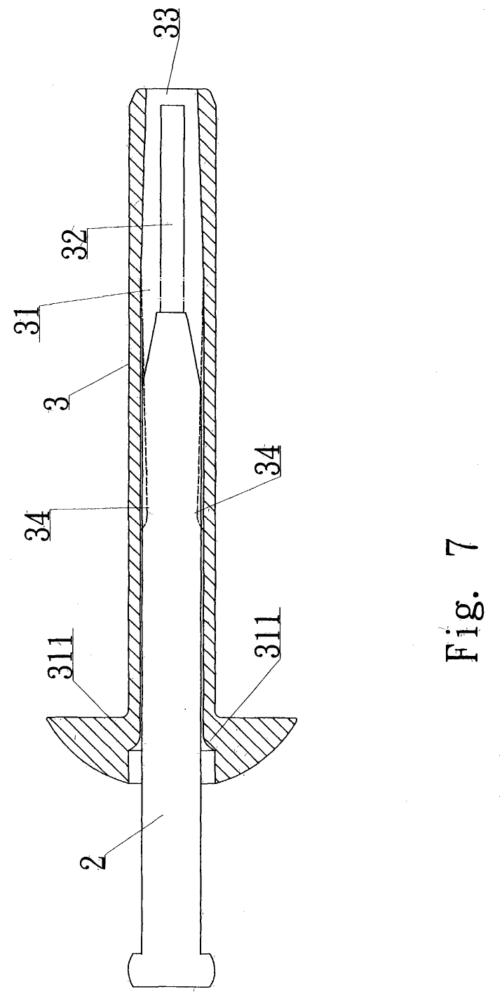

Referring to FIGS. 5 to 7, after the hammer nail 2 is beaten into the wall nail casing 3, the hammer nail 2 will be buckled to the strips 34 protruded from a wall of the through hole 33. The hammer nail 2 can be positioned to an opening of the wall nail casing 3 and resist against the strips 34. Thereby, the hammer nail 2 can be loosely fixed to the strips 34 so that in selling, the hammer nail fixed to the wall nail casing is sold together. Thereby, the hammer nail 2 is sold with a matched wall nail casing 3. When using, the hammer nail 2 is not necessary to be detached from the wall nail casing 3. The user can beat the hammer nail 2 directly with the wall nail casing 3 so that the hammer nail 2 and wall nail casing 3 are fixed to an object together.

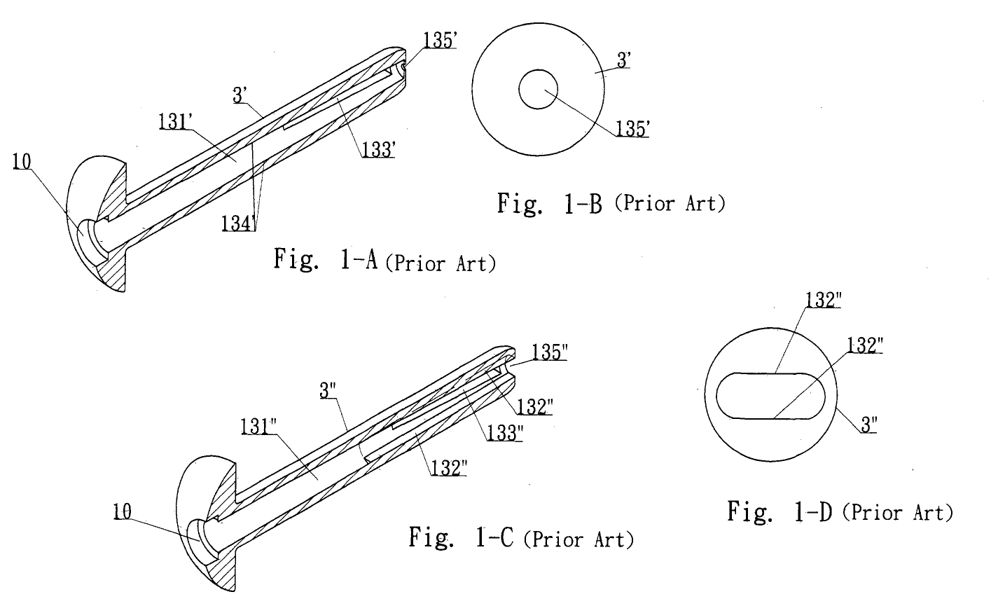

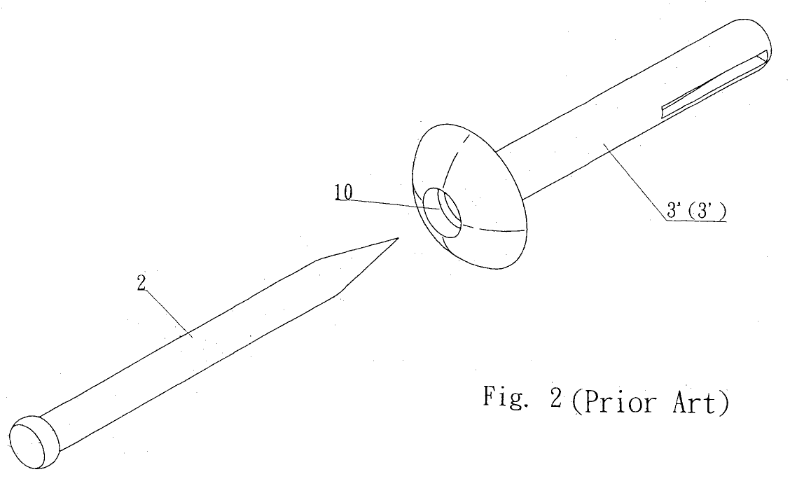

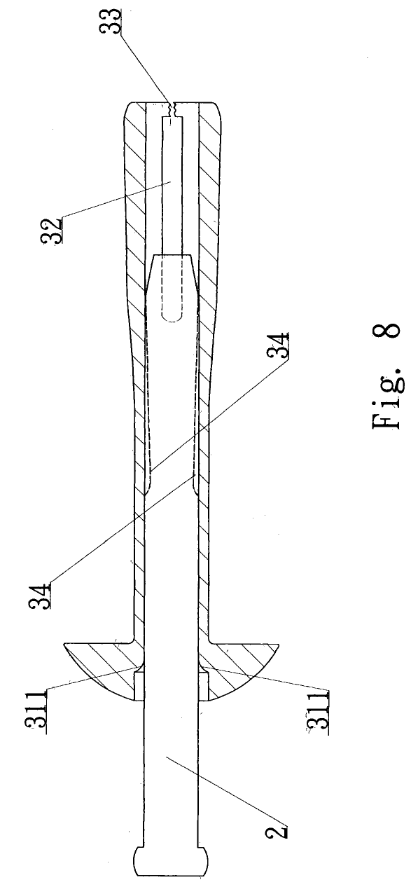

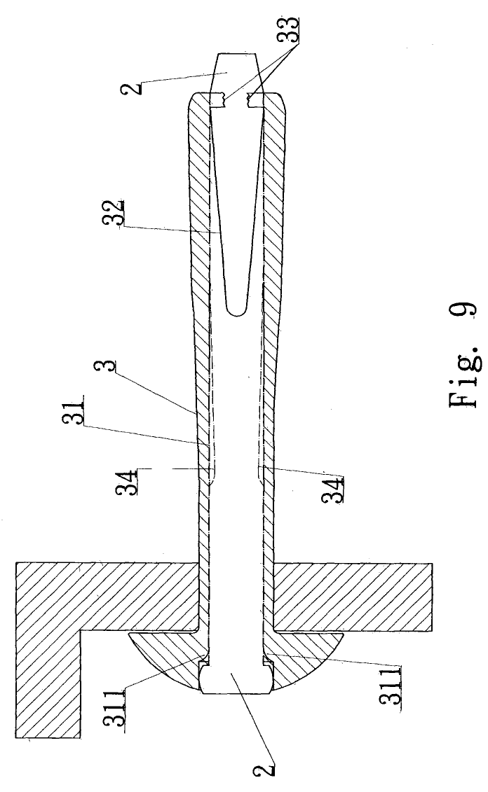

With reference to FIGS. 8 and 9, it is illustrated that the hammer nail 2 is positioned at the inlet of the wall nail casing 3. The distal end of the wall nail casing 3 is not expanded by the hammer nail 2. The strips 34 have found shape so that the hammer nail 2 can be buffered by the strips. Since a plurality of strips 34 are arranged around the inner wall of the wall nail casing 3, the hammer nail 2 does not wholly contact with the wall of the wall nail casing 3. Thus when the hammer nail 2 is beaten into the wall nail casing 3, the wall nail casing 3 will not break. The function of the strips 112 causes that the hammer nail 2 does not expand and thus not to break the wall of the hammer nail 2. Thus, the defect in the prior art as shown in 3′ and 3″ of FIG. 1 is improved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A nail structure comprises a wall nail casing and a hammer nail capable of being beaten into the wall nail casing; a center of the wall nail casing being formed with a tapered central axial hole at one end of the wall nail casing; two sides of another end of the wall nail casing being formed with an expandable slot; a through hole is formed within the wall nail casing and being communicable to the central axial hole so that the whole wall nail casing is hollowed axially; characterized in that:
a head portion of the wall nail casing penetrating by the central axial hole is formed with a tapered throat portion;
a plurality of semi-round strips are axially installed at a section of the through hole of the wall nail casing near the central axial hole and far away from the head portion; each strip is reduced with the distance to the head portion;
wherein after the hammer nail is beaten into the wall nail casing, the hammer nail will be buckled by the strips protruded from a wall of the central axial hole; the hammer nail is positioned in the wall nail casing and resists against the strips; thereby, the hammer nail is loosely fixed to the strips so that in selling, the hammer nail fixed to the wall nail casing is sold together with the wall nail casing; thereby, the hammer nail is sold with a matched wall nail casing; when using, the hammer nail is not necessary to be detached from the wall nail casing; the user can beat the hammer nail directly with the wall nail casing so that the hammer nail and wall nail casing are fixed to an object together.
